(19) United States
(12) Patent Application Publication
(10) Pub. No.: US 2026/0219968 A1
(43) Pub. Date: Jul. 30, 2026

(54) PREVENTING HOSTS FROM USING NETWORK INTERFACE CONTROLLER ADAPTERS ASSIGNED TO MANAGEMENT CONTROLLERS

(71) Applicant: HEWLETT PACKARD ENTERPRISE DEVELOPMENT LP, Spring, TX (US)

(72) Inventors: David F. Heinrich, Spring, TX (US); Mark I. Bain, Spring, TX (US); Kevin G. Depew, Spring, TX (US)

(21) Appl. No.: 19/038,291

(22) Filed: Jan. 27, 2025

(51) Int. Cl. G06F 9/54; G06F 13/40; G06F 21/85

(52) U.S. Cl. CPC G06F 9/541; G06F 13/4068; G06F 21/85

(57) ABSTRACT

A management controller of a computer platform manages a host of the computer platform. The management includes communicating, by the management controller and using a sideband channel interface of a network interface controller adapter, network traffic with a remote management service. The network interface controller adapter includes a host interface. The computer platform is configured to assign the network interface controller adapter to the management controller. Assigning the network interface controller to the management controller includes preventing the host from using the host interface.

### BACKGROUND

A computer system may include one or multiple management controllers that monitor and manage the physical state of the computer system. A management controller communicates with a management system through a management network. A chassis management controller, which monitors and manages multiple servers, is an example of a management controller. A baseboard management controller, or BMC, which monitors and manages a particular server, is another example of a management controller.

### BRIEF DESCRIPTION OF THE DRAWINGS

FIG. 1 is a block diagram of a computer platform that maintains a host interface of a network interface controller (NIC) adapter that is assigned to a baseboard management controller (BMC) in reset to prevent a host from using the NIC adapter, according to an example implementation.

FIG. 2 is a flow diagram depicting a technique to control a reset signal to prevent a host from using a NIC adapter that is assigned to a BMC, according to an example implementation.

FIG. 3 is a flow diagram depicting a technique used by system firmware to disable a root port to prevent a host from using a NIC adapter that is assigned to a BMC, according to an example implementation.

FIG. 4 is a block diagram of a computer platform that has a physical barrier to prevent a host from using a NIC adapter that is assigned to a BMC, according to an example implementation.

FIG. 5 is a block diagram of a computer platform that has a switch to prevent a host from using a NIC adapter that is assigned to a BMC, according to an example implementation.

FIG. 6 is a flow diagram depicting a technique to control switches to configure prevent a host from using a NIC adapter that is assigned to a BMC, according to an example implementation.

FIG. 7 is a flow diagram depicting a technique to prevent a host from using a NIC adapter that is assigned to a BMC, according to an example implementation.

FIG. 8 is a block diagram of a computer platform having a concealment engine to prevent a host from using a NIC adapter that is dedicated for use by a BMC, according to an example implementation.

FIG. 9 is a block diagram of a computer platform having a physical communication barrier to prevent a host from using a NIC adapter that is dedicated for use by a BMC, according to an example implementation.

### DETAILED DESCRIPTION

In the management of a computer system, a management controller may communicate management network traffic with remotely-located management services (called "remote management services" herein). Management network traffic may be communicated over a persistent network connection, such as a Transport Control Protocol (TCP) connection and an overlaying WebSocket communication protocol, over which multiple requests and responses are communicated. Management network traffic may also be communicated over a non-persistent, or short-lived, network connection, such as a TCP connection and an overlaying Hypertext Transfer Protocol (HTTP), over which a Representational State Transfer (REST) API request and a corresponding REST API response are communicated before the connection is terminated. In an example, management network traffic includes messages. In another example, management network traffic includes content other than messages (e.g., data representing a firmware image or a software patch).

A management controller may send and receive management network traffic for any of a number of purposes. In an example, for a BMC, the management network traffic includes event messages (e.g., Redfish events) that the BMC sends, to a remote management service, for purposes of reporting events (e.g., button presses, tampering detections, and out-of-range telemetry values) that are associated with a host that is managed by the BMC. In another example, management network traffic corresponds to messaging for purposes of the management controller receiving a firmware update or a software patch. In another example, management network traffic corresponds to messaging related to a remote management service querying a management controller about a software inventory, a hardware inventory and/or configuration of a computer system. In other examples, management network traffic corresponds to messaging related to a remote management service configuring a computer system or controlling a power state.

In one approach to providing a management controller with the capability to send and receive management network traffic, the management controller has a built-in, or internal, network interface controller (or "NIC"). The built-in NIC is dedicated solely to communicating management network traffic for the management controller. As a more specific example, a BMC may have a built-in NIC. Because a given BMC design may be used in a wide variety of server designs and applications, it may be advantageous for the BMC to have an infrastructure to natively support a broad range of network interfaces. The network interfaces may be associated with a variety of network communication protocols and physical network media. Incorporating infrastructure into a BMC for purposes of natively supporting a number of network interface options may significantly add to the cost of the BMC and server, as each supported network interface type may correspond to dedicated BMC resources. In examples, a natively-supported network interface may correspond to such dedicated BMC resources as specific application specific integrated circuit (ASIC) logic, an allocation of circuit board space and other network interface-specific adaptions (e.g., a paddle board).

As an alternative to having a built-in NIC, a management controller may use a network interface that is provided by a NIC expansion card, or adapter (herein called a "NIC adapter"), which is installed in a card edge connector of a server. In this way, a NIC adapter that supports a particular network communication protocol and specific physical network media may be selected for the management controller and installed in the card edge connector. The management controller is designed to communicate with the NIC adapter over a sideband channel bus, and for this purpose, the NIC adapter has a secondary interface (called a "sideband channel interface" herein). The NIC adapter is also designed to share its network interface with the server's host. In this manner, the NIC adapter includes a primary interface (called a "host interface" herein), which may be accessed by host application workloads via an expansion bus (e.g., a Peripheral Component Interconnect express (PCIe) bus) of the server. Therefore, unlike a built-in NIC that is dedicated exclusively for the management controller's management network traffic, a NIC adapter shares its network interface with both the management network traffic and host network traffic. For security reasons, some server customers may not want a server design in which host network traffic and management network traffic share the same network interface.

In accordance with example implementations, a computer platform (e.g., a server) is constructed to allow a management controller of the computer platform to be assigned to a NIC adapter that is installed in a card edge connector of the computer platform. The management controller, through a sideband channel bus, uses the NIC adapter's network interface to communicate management network traffic with remote management services. Although the NIC adapter has a host interface and is constructed to share its network interface with both host network traffic and management network traffic, the computer platform has host interface concealment features that prevent the host from discovering or using the host interface. Because the host is prevented from using the NIC adapter's host interface, the NIC adapter's network interface is dedicated for the exclusive use of the management controller.

In an example, the host interface of a NIC adapter is connected to an expansion bus of the computer platform by virtue of the NIC adapter being installed in a card edge connector. In an example, installing the NIC adapter in the card edge connector includes the NIC adapter being mechanically seated in the connector and a mechanical latch of the connector being engaged. Although for this example, the host interface is connected to the expansion bus due to the NIC adapter being installed in the card edge connector, the computer platform includes a host interface concealment engine that disables the host interface and therefore, prevents the host from discovering or using the host interface.

In an example, the host interface concealment engine is affiliated with the management controller. In a more specific example, the host interface concealment engine is part of reset logic that is controlled by the management controller. The reset logic maintains the NIC adapter's host interface in reset to prevent the host from discovering the host interface. In an example, the expansion bus is a Peripheral Component Interconnect express (PCIe) bus, and the host interface is a PCIe device. At power up, a PCIe device is initially held in reset. In the absence of host interface concealment features, a PCIe device is released from reset after the supply voltage and reference clock to the PCIe device have stabilized, and at this time, the PCIe device undergoes link training. During link training, the PCIe device sends and receives sets of training data for purposes of negotiating with the PCIe bus infrastructure and establishing configuration parameters (e.g., lane width, data rate and equalization parameters) that allow communication with the PCIe device.

Because the reset logic maintains the host interface of the NIC adapter in reset, link training for the host interface is suppressed, and as a consequence, the host does not recognize the host interface. In this context, “maintaining” the host interface in reset refers to placing the host interface in a reset state for a time interval that begins before, at or near the power up of the host and extends at least until a bus device discovery phase has completed and the host can no longer recognize the host interface. In an example, the reset logic maintains the host interface in reset for a continuous time period that begins at or before the beginning of the host's PCIe enumeration and ends after the PCIe enumeration has completed. In another example, the reset logic holds the host interface in reset for a time period that begins before, at or near the power up of the host and extends at least until a time near or when the host is powered down.

In another example, the host interface concealment engine is affiliated with pre-boot environment system firmware (e.g., a Unified Extensible Firmware Interface (UEFI) application) of the computer platform. The system firmware is configured to disable a bus infrastructure root port (e.g., a PCIe root port) that corresponds to the host interface. By disabling the root port, the host cannot discover or use the host interface.

In another example, the computer platform has a physical communication barrier that isolates the host interface of a NIC adapter assigned to a management controller from the host. The physical communication barrier may take on a number of different forms. In an example of a physical communication barrier, the computer platform has connectors for connecting a bus infrastructure (e.g., a PCIe bus infrastructure) of the host to the host interface. In this manner, the computer platform is designed so that a jumper cable may be plugged into the appropriate connectors for purposes of extending a bus infrastructure of the host to the host interface. To isolate the host from the host interface, the connector that is associated with the host interface is purposefully not connected, by a jumper cable, to a bus infrastructure of the host. Therefore, the omission of a jumper cable connection establishes a physical communication barrier that prevents the host from discovering or using the host interface. The management controller may then, via a sideband channel bus, use this NIC adapter to communicate with the network, without sharing the NIC adapter's network interface with the host.

In another example of a physical communication barrier, the computer platform includes, for each card edge connector of a collection of card edge connectors, an associated multi-line (or "multiple line") switch. The multi-line switch has two states to control whether or not the host is connected to the host interface of a NIC adapter installed in the connector. In a first state, the switch connects a bus infrastructure of the host to the host interface. In this manner, in the first state, the switch couples address, control and power lines of the host interface to respective address, data, control and power lines of a bus infrastructure of the host. In a second state, the switch isolates the host interface from the bus infrastructure.

In an example, the computer platform allows a user option-selectable assignment of a given edge connector to a management controller so that a NIC adapter installed in the given card edge connector may be used exclusively by the management controller. The corresponding multi-line switch is controlled to isolate the host interface of the NIC adapter installed in the given card edge connector from the host. The management controller may then, via a sideband channel bus, use this NIC adapter to communicate with the network without sharing the NIC adapter's network interface with the host. In an example, the other multi-line switches, by default, connect the host interfaces of the NIC adapters installed in the other card edge connectors to the host.

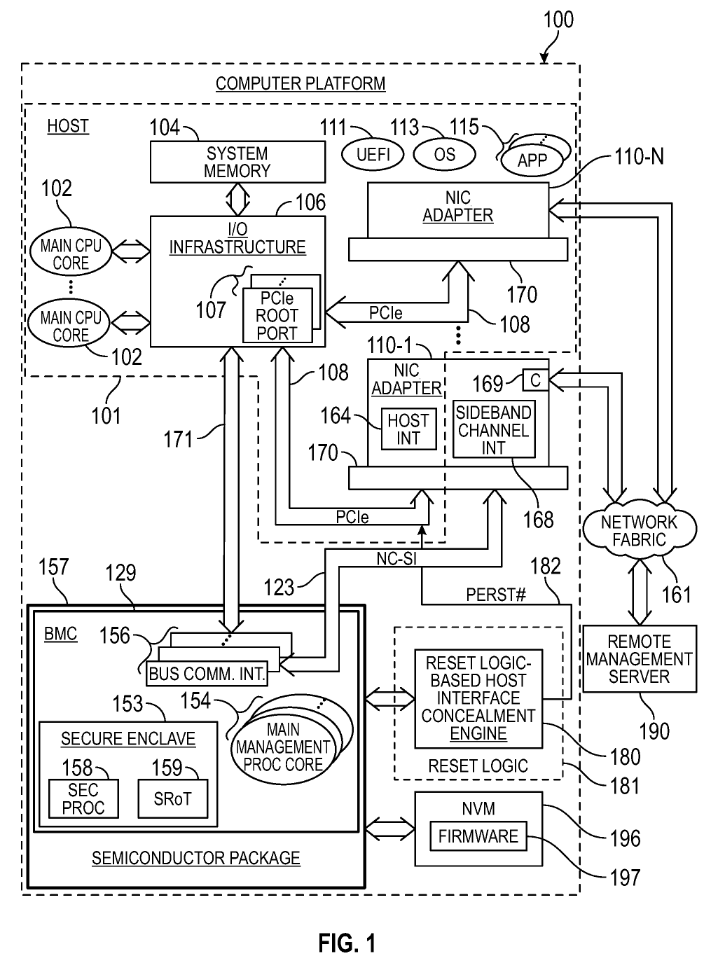

Referring to FIG. 1, in accordance with some implementations, a computer platform 100 includes a host 101 and a BMC 129 that manages the host 101. In the context that is used herein, a "host" refers to a collection of components of the computer platform 100, which provide one or multiple application operating environments in which application workloads (corresponding to application processes 115) run, or execute. In examples, the application operating environments may be bare-metal environments, virtual machines, containers or a combination thereof. Although a single host 101 is described herein, in accordance with further example implementations, the computer platform 100 may include multiple hosts 101, and the BMC 129 manages each host 101.

The computer platform 100, in accordance with example implementations, is a modular unit, which includes a frame, or chassis. Moreover, this modular unit may include hardware that is mounted to the chassis and is capable of executing machine-readable instructions. In examples, the computer platform 100 is a server, such as an enclosure-based server (e.g., a blade server); a rack server; or a stand-alone server (e.g., a tower server). In other examples, the computer platform 100 may be a component other than a server, such as a client, a desktop, a smartphone, a wearable computer, a networking component, a gateway, a network switch, a storage array, a portable electronic device, a portable computer, a tablet computer, a thin client, a laptop computer, a television, a modular switch, a consumer electronics device, an appliance, an edge processing system, a sensor system, a watch, a removable peripheral card, or, in general, any other processor-based electronic device.

For the example implementation that is depicted in FIG. 1, the host 101 includes main central processing unit (CPU) cores 102 and memory devices that are connected to the main CPU core(s) 102 to form a system memory 104. The host 101 operates under control of an operating system 113 (e.g., a LINUX operating system, a WINDOWS operating system or other operating system) independently of the BMC 129. In general, the memory devices that form the system memory 104, as well as other memories and storage media that are described herein, may be formed from non-transitory memory devices, such as semiconductor storage devices, flash memory devices, memristors, phase change memory devices, a combination of one or more of the foregoing storage technologies, and so forth. Moreover, the memory devices may be volatile memory devices (e.g., dynamic random access memory (DRAM) devices, static random access (SRAM) devices, and so forth) or non-volatile memory devices (e.g., flash memory devices, read only memory (ROM) devices and so forth), unless otherwise stated herein.

The BMC 129, in accordance with example implementations, includes a management plane and a security plane that is isolated from the management plane. The management plane includes one or multiple main management processing cores 154 (e.g., CPU cores) that execute instructions of a BMC firmware management stack for purposes of performing a variety of management-related functions for the host 101. As examples, the BMC 129 provides such management-related functions as operating system runtime services; resource detection and initialization; and pre-operating system services. In other examples, the management-related functions include the BMC 129 monitoring telemetry values (e.g., cooling fan speeds and temperature sensors) and reporting unexpected or out-of-range telemetry values.

The management-related functions may also include remotely-controlled functions. As examples, the remotely-controlled functions include keyboard video mouse (KVM) functions; virtual power functions (e.g., remotely activated functions to remotely set a power state, such as a power conservation state, a power on, a reset state or a power off state); virtual media management functions; and/or one or multiple other management-related functions for the host 101.

The BMC 129 includes a secure enclave 153 for purposes of providing security-related services for the host 101. The secure enclave 153, in accordance with example implementations, is fully disposed inside a cryptographic boundary. A "cryptographic boundary" in this context refers to a continuous boundary, or perimeter, which contains the logical and physical components of a cryptographic subsystem, such as BMC components that form the secure enclave 153. The secure enclave 153, in accordance with example implementations, is isolated from the BMC's management plane. In the context used herein, a "secure enclave" refers to a subsystem, such as a subsystem of the BMC 129, for which access into and out of the subsystem is tightly controlled. The secure enclave 153 can also be referred to as a "secure boundary" or a "secure perimeter," or any other like term. Among its other components, the secure enclave 153 includes a security processor 158 (e.g., one or multiple CPU cores) that executes instructions to provide security-related functions for the host 101. Moreover, the secure enclave 153 includes a silicon root of trust (SRoT) engine 159, which serves as a hardware trust anchor for the computer platform 100.

In an example of a security-related service, the secure enclave 153 stores an immutable fingerprint, which, on a power up of the BMC 129, is used by the SRoT engine 159 to validate an initial portion of system firmware 197 (stored in a non-volatile memory 196) before a security processor 158 of the secure enclave 153 executes the initial portion. In another example of a security-related service, the secure enclave 153 validates the firmware management stack that is executed by the main management processing cores 154. In another example of a security-related service, the SRoT engine 159 anchors a cryptographic chain of trust for the computer platform 100, which extends to the firmware management stack that is executed by the BMC's main processing cores 154. When the host 101 boots, the firmware management stack that is executed by the main management processing core(s) 154 validates host system firmware, such as UEFI 111 firmware, thereby extending the chain of trust to the host system firmware.

In another example of a security-related service, the secure enclave 153 manages the storage of cryptographic artifacts (e.g., certificates, keys, digital certificates and seeds) for the host 101. In other examples, the secure enclave 153 provides cryptographic services. In examples, a cryptographic service may be a key generation service, a signature validation service, an encryption service, a decryption service, a hashing service, a true random number generation service or a deterministic random number generation (DRNG) service. In another example of a security-related service, the secure enclave 153 detects and reports an unexpected inventory of the host 101 (e.g., an observed inventory that is different from an inventory corresponding to a base platform certificate and any delta platform certificate(s)). In another example of a security-related service, the secure enclave 153 reports an attestation value (e.g., a signed measurement digest) measured in connection with a measured boot of the host 101. In another example of a security-related service, the secure enclave 153 monitors environmental signals (e.g., sensor signals representing a die temperature, a clock rate, a supply voltage magnitude, an enclosure opening status, a removal status, and so forth) of the computer platform 100 for purposes of detecting tampering, and the secure enclave 153 reports any detected tampering events.

In accordance with example implementations, in the course of performing its management-related services and security-related services, the BMC 129 communicates management network traffic with one or multiple remote management services that are hosted on a remote management server 190. In the context that is used herein, "management network traffic" refers to content that is communicated via a network interface of the computer platform 100 in association with a management-related service or a security-related service provided by the BMC 129. In an example, management network traffic includes messages (e.g., API request messages and API response messages). In another example, management network traffic includes content other than messages (e.g., data representing a firmware image or software patch).

In an example of management network traffic associated with the BMC's management-related services, the management traffic includes an event message that the BMC 129 sends to report an unexpected (e.g., out-of-range) telemetry value associated with the host 101. In another example, the management network traffic includes a message that the BMC 129 sends to report a detected hardware fault associated with a hardware component of the host 101. In another example, the management network traffic includes a message that the BMC 129 sends to report a detected software fault associated with the host 101. In another example, the management network traffic includes messaging related to the BMC 129 requesting and receiving a firmware upgrade package or software patch. In examples, a firmware upgrade may be associated with the BMC's firmware management stack or system firmware (e.g., firmware related to pre-boot or post-boot UEFI services 111). In another example, the management network traffic includes messaging related to queries that are initiated by a remote management service. For example, the messaging may include an inquiry, from a remote management service, about an inventory or configuration, of the host 101, and a corresponding response from the BMC 129. In other examples, the management network traffic includes messaging between the BMC 129 and a remote management service to configure the host 101, control host power (e.g., power up or power down the host 101) or manage the host's virtual media.

In an example of management network traffic associated with the BMC's security-related services, the management network traffic includes a message sent by the BMC 129 to report detected tampering with the computer platform 100. In another example, the management network traffic includes a message sent by the BMC 129 to report an unexpected inventory. In another example, the management network traffic includes a message sent by the BMC 129 to report an attestation value measured during a measured boot. In another example, the management network traffic includes a message sent by the BMC 129 to report an unexpected measurement during a trusted boot. In another example, the management network traffic includes a message sent by the BMC 129 to report a failure of the validation of the initial portion of the firmware 197. In another example, the management network traffic includes a message sent by a remote management service and to the BMC 129 to add, change or delete a cryptographic artifact. In another example, the management network traffic includes messaging between a remote management service and the BMC 129 to change an ownership token associated with the BMC's firmware management stack.

For the example implementation that is depicted in FIG. 1, the BMC 129 is assigned to a NIC adapter 110-1 of the computer platform 100. In this context, the "assignment" of the BMC 129 to a NIC adapter, such as the NIC adapter 110-1, refers to the BMC 129 exclusively using the NIC adapter's network interface (i.e., the BMC does not share the network interface with another entity, such as the host 101).

The BMC 129 uses the NIC adapter 110-1 to communicate with remote management services that are hosted on one or multiple remote management servers 190. The NIC adapter 110-1 is one of N NIC adapters (NIC adapters 110-1 and 110-N being specifically depicted in FIG. 1) that may be installed in respective card edge connectors 170 of the computer platform 100. In an example, one or multiple of the card edge connectors 170 may be electrically and mechanically mounted to a motherboard of the computer platform 100. In another example, one or multiple of the card edge connectors 170 may be electrically and mechanically mounted to a riser board of the computer platform 100.

In an example, the card edge connectors 170 are Open Compute Project NIC 3.0 (OCP3) connectors, and the NIC adapters 110 are OCP3 NIC adapters. The mechanical requirements and electrical interface for OCP3 NIC adapters are described in "OCP NIC 3.0 Design Specification," Version 1.5.0, September 20, 2024, and is available from the Open Compute Project Foundation. One or multiple of the card edge connectors 170 may conform to a specification other than the OCP3 NIC 3.0 Specification, in accordance with further implementations.

The NIC adapter 110-1 includes one or multiple network interface connectors 169 for purposes of forming signal and mechanical connections with respective cable(s) (e.g., a twisted pair cable, a shielded balanced copper cable or an optical fiber cable) to connect the NIC adapter 110-1 with a network fabric 161. In accordance with example implementations, the network fabric 161 may be associated with one or multiple types of physical network media and communication networks, including Compute eXpress Link (CXL) fabric, dedicated management networks, local area networks (LANs), wide area networks (WANs), global networks (e.g., the Internet), wireless networks, or any combination thereof. In an example, the NIC adapter 110-1 provides a 1000Base-T, 1 Gigabit per second (Gbps) Ethernet network interface, and as examples, the NIC adapter 110-1 includes either a single RJ-45 connector 169 or multiple RJ-45 connectors 169 (for link aggregation). In another example, the NIC adapter 110-1 provides a 10 Gbps Fiber Ethernet network interface, and the NIC adapter 110-1 includes a Lucent Connector (LC), or other fiber connector. The NIC adapter 110-1 may provide any of a number of other network interfaces for the BMC 129. In general, due to the flexibility provided by the choice of network adapters for installing in the computer platform 100, the specific selection of the network adapter 110-1 allows customization of the computer platform 100 to suit the networking requirements of the BMC 129. The ability to select a specific network interface for the BMC 129 may be particularly advantageous for data centers that impose certain network criteria (e.g., a data center requirement that all networking is to be fiber-based).

The BMC 129 communicates with the NIC adapter 110-1 using a sideband channel bus 123 of the computer platform 100. A "bus," in the context that is used herein, refers to any communication link that includes a collection of signal lines (a single signal line or multiple signal lines) over which data can be transferred. A sideband channel interface 168 of the NIC adapter 110-1 is a bus agent, or device, coupled to the sideband channel bus 123. In this context, a "sideband channel bus" refers to a communication link that is separate and independent from the communication links, or buses, of the host 101. The BMC's communication with the NIC adapter 110-1 includes the BMC 129 transmitting, to the sideband channel bus 123, bus traffic that is received by the sideband channel interface 168 and results in the NIC adapter 110-1 sending corresponding management network traffic (e.g., messages and data representing various content) over the network fabric 161. Moreover, the BMC's communication with the NIC adapter 110-1 includes the BMC 129 receiving, from the sideband channel bus 123, bus traffic that is communicated to the bus 123 by the sideband channel interface 168 and is a result of the NIC adapter 110-1 receiving corresponding management network traffic from the network fabric 161.

In an example and as depicted in FIG. 1, the sideband channel bus 123 is a Network Controller-Sideband Intercommunication (NC-SI) bus that adheres to a communication protocol that is described in the NC-SI Specification, which is published by the Distributed Management Task Force (2009). For example implementations in which the sideband channel bus 123 is an NC-SI-compliant bus, the sideband channel interface 168 is also NC-SI compliant. In other examples, the sideband channel bus 123 is another type of bus, such as a Serial Peripheral Interface (SPI) bus, an Inter-Integrated Circuit (I2C) bus, an Improved I2C (I3C) bus or a system management bus (SMB). For these examples, the sideband channel interface 168 complies with the standard associated with the sideband channel bus 123.

Although the NIC adapter 110-1 is constructed to share its network interface with the host 101, via a host interface 164, host concealment features of the computer platform 100 prevent the host 101 from discovering or using the host interface 164. For the example implementation that is depicted in FIG. 1, by virtue of the NIC adapter 110-1 being installed in the card edge connector 170, the host interface 164 is connected to the host 101. Without the host interface concealment features of the computer platform 100, which are described herein, the host interface 164 is otherwise discoverable by the host 101.

In an example, the host interface 164 is a PCIe interface, and when the NIC adapter 110-1 is installed in the card edge connector 170, the host interface 164 is connected to a PCIe bus infrastructure of the host 101. This means that without the host interface concealment features of the computer platform 100, the host interface 164 is discovered in a process called "enumeration" (e.g., PCIe enumeration). In accordance with further implementations, the host interface 164 may be associated with a bus other than a PCIe bus, such as, for example, an Infiniband bus.

The host interface concealment features may take on a number of different forms, depending on the particular implementation. For the example implementation that is depicted in FIG. 1, the computer platform 100 includes a reset logic-based host interface concealment engine 180 (called the "concealment engine 180" herein). The concealment engine 180 is constructed to control a reset signal of the host interface 164 to suppress PCIe link training for the host interface 164. During PCIe link training, a PCIe endpoint device sends and receives sets of training data for purposes of negotiating with the PCIe bus infrastructure and establishing configuration parameters for communication with the PCIe endpoint device, such as the number of lanes of the bus (called the "lane width") the data rate and equalization parameters. By maintaining the host interface 164 in reset and suppressing PCIe link training for the host interface 164, the host 101 does not discover the host interface 164 during enumeration, and consequentially, the host 101 does not thereafter use the host interface 164.

As depicted in FIG. 1, the concealment engine 180, in accordance with example implementations, is part of reset logic 181 (e.g., a complex programmable logic device (CPLD)) that is controlled in part by the BMC 129. The reset logic 181 generates reset signals to, in an initial phase of the power up of the host 101, hold components of the host 101, such as the main CPU cores 102 and PCIe end devices, in reset. Responsive to a certain number of conditions being satisfied (e.g., firmware being successfully validated and no detected hardware faults), the BMC 129 allows the reset logic 181 to release components of the host 101 from reset. For PCIe endpoint devices, the reset logic 181 monitors the PCIe bus supply voltage and the PCIe reference clock signal that are provided to the PCIe endpoint devices. The reset logic 181, in general, releases a PCIe endpoint device from reset responsive to the release being permitted by the BMC 129 and responsive to the device's PCIe reference clock signal and supply voltage stabilizing. The concealment engine 180, however, regulates the reset state of the host interface 164 differently so that the host interface 164 is not released from reset.

More specifically, in accordance with example implementations, the concealment engine 180 generates a PCIe reset signal (called "PERST#") on an output terminal 182, which is coupled to the PERST# terminal of the host interface 184. The host interface 164 is placed in a reset state responsive to the PERST# signal being asserted (e.g., the PERST# signal having a logic zero level), and the host interface 164 is released from the reset state otherwise. In accordance with some implementations, responsive to the host 101 being powered up (or even before the host 101 powers up), the concealment engine 180 asserts the PERST# signal (e.g., drives the PERST# signal to a logic zero level) and maintains the assertion of the PERST# signal to keep the host interface 164 in reset during a time span that extends through PCIe bus enumeration if not longer (e.g., the PERST# signal is asserted during the entire time that the host 101 is powered up). Because the host interface 164 is held in reset, the host 101 does not discover the host interface 164 during PCIe enumeration and thereafter does not use the host interface 164. Accordingly, the BMC 129 exclusively uses the network interface of the NIC adapter 110-1 and does not share the network interface with the host 101.

In accordance with example implementations, the computer platform 100 has a main power supply (not shown) that, in general, provides one or multiple main supply rail voltages to power components of the host 101. The computer platform 100 also has an auxiliary power supply (not shown), which provides one or multiple auxiliary supply rail voltages to power certain components of the computer platform 100 when AC power is available (e.g., when a power cord for the computer platform 100 is plugged into a power receptacle). The components of the BMC 129, including the secure enclave 153, the main management processing cores 154, memory devices and bus communication interfaces 156, power on when the auxiliary power is available. Moreover, in accordance with example implementations, the reset logic 181 is powered by auxiliary power. The card edge connector 170 corresponding to the NIC adapter 110-1 also receives auxiliary power, which allows the BMC 129 to communicate with the remote management server 190 when the main power is unavailable but the auxiliary power is available. This feature allows the BMC 129 to provide "lights out" management for the computer platform 100. The powering on of the host 101 occurs in response to a host power on request, which the BMC 129 processes when the BMC 129 is fully powered via the auxiliary power.

Among the other features of the host 101, the main CPU cores 102 may be coupled to an input/output (I/O) infrastructure 106. The I/O infrastructure 106 allows communications between the main CPU cores 102 and the BMC 129. The I/O infrastructure 106 also allows communications, by the main CPU cores 102, with various other components of the computer platform 100, such as the system memory 104; one or multiple storage drives; one or multiple Universal Serial Bus (USB) devices; I/O devices; a video controller; and so forth.

The I/O infrastructure 106 may take on any one of a number of different forms. In an example, the I/O infrastructure 106 includes one or multiple bridges (e.g., a platform controller hub (PCH)). Depending on the particular implementation, the I/O infrastructure 106 may be fully or partially integrated with the main CPU cores 102 or may be separate from the main CPU cores 102. In an example, the I/O infrastructure 106 includes PCIe root ports 107. The PCIe root ports 107 may be associated with one or multiple PCIe root complexes. In an example, the computer platform 100 has a single PCIe root complex. In another example, the computer platform 100 has multiple PCIe root complexes. In another example, each main CPU core 102 corresponds to a PCIe root complex and has an associated collection of PCIe root ports 107.

In accordance with example implementations, each PCIe endpoint device, such as a host interface of a NIC adapter 110, is associated with a particular PCIe infrastructure. A PCIe infrastructure includes a PCIe link, or bus 108 (called a "PCIe bus 108" herein), and an associated PCIe root port 107. Although not depicted in FIG. 1, a particular PCIe infrastructure may include a PCIe hub, or switch, and be associated with multiple hub ports and multiple corresponding PCIe endpoint devices.

The host 101 may communicate with the BMC 129 via communications that occur over one or multiple host buses 171. The host buses 171 connect to respective bus communication interfaces 156 of the BMC 129. In an example, for host communications, the bus communication interfaces 156 contain registers that are associated with an API that is provided by the management plane of the BMC 129. Through the API, application workloads may communicate with the BMC 129 using an input/output control (IOCTL) interface driver, REST API calls (e.g., Redfish API calls), or some other system software proxy. Moreover, the BMC 129 includes a bus communication interface 156, such as an NC-SI-compliant interface, which is constructed to generate signals on and receive signals from the sideband channel bus 123.

As depicted in FIG. 1, in accordance with example implementations, the components of the BMC 129 are located inside a semiconductor package (or "chip") 157. Depending on the particular implementation, the semiconductor package 157 may contain one die or multiple dies. The semiconductor package 157 may have one of many different forms. In an example, a semiconductor package 157 may contain one or multiple dies (corresponding to respective integrated circuits) that are mounted on a printed circuit board (PCB) substrate that interconnects the dies. In another example, a semiconductor package 157 may contain multiple dies that are interconnected by bonding wires. In an example, a semiconductor package is encapsulated. In another example, a semiconductor package 157 is not encapsulated. In other examples, a semiconductor package 157 may correspond to any of a number of different containers, such as a surface mount package, a through-hole package, a ball-grid array package, a small outline package or a chip-scale package. Regardless of its particular form, the semiconductor package 157 operatively electrically couples its integrated circuit(s) to a motherboard of the computer platform 100.

As used herein, an "engine," such as the concealment engine 180, can refer to one or more circuits. For example, the circuits may be hardware processing circuits, which can include any or some combination of a microprocessor, a core of a multi-core microprocessor, a microcontroller, a programmable integrated circuit (e.g., a programmable logic device (PLD), such as a CPLD), a programmable gate array (e.g., field programmable gate array (FPGA)), an application specific integrated circuit (ASIC), or another hardware processing circuit. An "engine" can refer to a combination of one or more hardware processing circuits and machine-readable instructions (software and/or firmware) executable on the one or more hardware processing circuits. In other examples, the concealment engine 180 can be formed in whole or in part by a CPLD, a PLD, an ASIC, an FPGA or other hardware. In an example and as described in connection with FIG. 1, the concealment engine 180 is part of reset logic 181. In accordance with further implementations, the concealment engine 180 may be formed by a hardware processor, such as a main management processing core 154, executing machine-readable instructions that are stored in a memory.

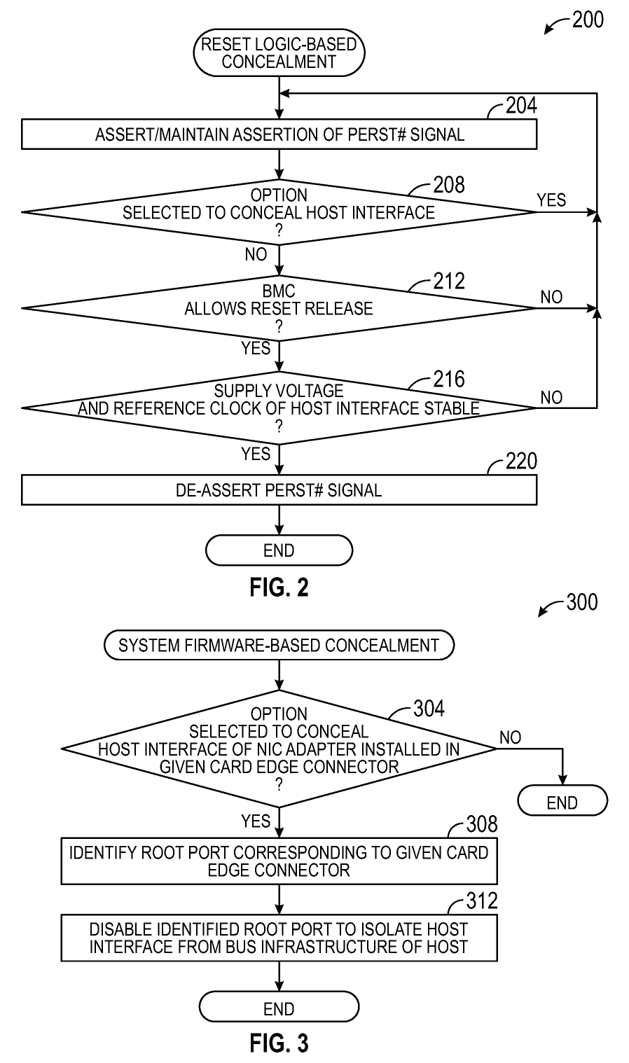

FIG. 2 depicts a technique 200 to control the reset state of a host interface of a NIC adapter according to an example implementation. Referring to FIG. 2, the technique 200 may be performed by reset logic that has host interface concealment features, such as, for example, the reset logic 181 of FIG. 1. The reset logic performs the technique 200, in accordance with example implementations, for each card edge connector that is constructed to receive a NIC adapter having host and sideband channel interfaces. In an example, the card edge connectors may be OCP3-compliant. The NIC adapter 110-1 of FIG. 1 is an example of such a NIC adapter. In the following discussion, it is assumed that the host interface is a PCIe interface, and the host interface is placed in a reset state by the assertion of the PERST# signal.

Pursuant to block 204 of the technique 200, the reset logic asserts and/or maintains assertion of the PERST# signal associated with the card edge connector. In an example, in response to the auxiliary power supply being available, the reset logic asserts the PERST# signal for each PCIe-based host interface of the computer platform. The reset logic, in general, maintains the assertion of the PERST# signal based on the conditions that are set forth in the technique 200.

More specifically, pursuant to block 208 of the technique 200, the reset logic determines if an option has been selected to conceal the host interface of the NIC adapter installed in the card edge connector. Stated differently, the option selects, for a particular card edge connector, whether the corresponding installed NIC adapter is assigned to the BMC (and therefore, is to be used exclusively by the BMC). If so, then, as depicted in FIG. 2, the reset logic returns to block 204 for purposes of maintaining the assertion of the PERST# signal. Stated differently, the reset logic continuously maintains the host interface of the NIC adapter in reset to suppress link training and accordingly, prevent the host interface from being discovered or used by the host.

A particular card edge connector (and its corresponding installed NIC adapter) may not be assigned to the BMC. If, pursuant to decision block 208, a determination is made that an option has not been selected to assign the card edge connector to the BMC, then the reset logic determines whether conditions are satisfied for purposes of releasing the host interface from reset. In an example, a first condition is that the reset logic determines (decision block 212) whether the BMC allows the host interface to be released from reset.

More specifically, in accordance with example implementations, the BMC constrains the reset release based on one or multiple criteria. In an example, the BMC does not allow the host interface to be released from reset until one or multiple initial portions of the firmware are validated by the BMC. For example, the validation may include validating the initial firmware portion that is executed by the BMC's security processor. In another example, the BMC does not allow the host interface to be released from reset until other portions of the firmware are validated, such as the initial portion of the firmware that is executed by the BMC's management processors. In another example, the BMC does not allow the host interface to be released from reset until the BMC validates the firmware management stack image. In another example, the BMC does not allow the host interface to be released from reset until the BMC performs certain hardware fault checks and determines that no hardware faults are detected.

If a determination is made, pursuant to decision block 212, that the BMC allows the host interface to be released from reset, then the reset logic determines whether conditions that are specific to the host interface are satisfied for purposes of releasing the reset. In an example, as depicted in decision block 216, the reset logic determines whether the supply voltage and the reference clock of the host interface are stable. If not, then, as depicted by the return of control to block 204, the reset logic waits until the supply voltage and the reference clock are stable. If the reset logic determines (decision block 216) that both the supply voltage and the reference clock of the host interface are stable, then, as depicted in block 220, the reset logic de-asserts the PERST# signal (e.g., allows the PERST# signal to be pulled up to a logic one level), which releases the host interface from reset. After being released from reset, the host interface may then participate in link training, which results in the host interface being discovered in PCIe enumeration.

FIG. 3 depicts a flow diagram illustrating a system firmware-based technique 300 to conceal a host interface of a NIC adapter that is assigned to a BMC. Referring to FIG. 3, in an example, the technique 300 is performed by an UEFI application as part of the boot of a host of a computer platform. For this example, it is assumed that a given card edge connector of the computer platform has been designated, via a user-selectable configuration option, to receive a NIC adapter that is assigned to the BMC. The NIC adapter 110-1 of FIG. 1 is an example of such a NIC adapter.

The technique 300 includes determining (block 304) whether a user-selectable option has been selected to conceal the host interface of a NIC adapter that is installed in a given card edge connector. In an example, a particular card edge connector of the computer platform may be designated, via an UEFI option, to be assigned to the BMC. In an example, the given card edge connector is associated with a PCIe bus infrastructure of the computer platform, and the PCIe bus infrastructure is associated with particular PCIe root port.

Pursuant to block 308 of the technique 300, the system firmware identifies the root port corresponding to the given card edge connector. Pursuant to block 312 of the technique 300, the system firmware disables the identified root port. By disabling the root port, the host is prevented from discovering or using the NIC adapter installed in the given card edge connector. Accordingly, the BMC may, via a sideband channel bus (e.g., the sideband channel bus 123 of FIG. 1), exclusively use the NIC adapter.

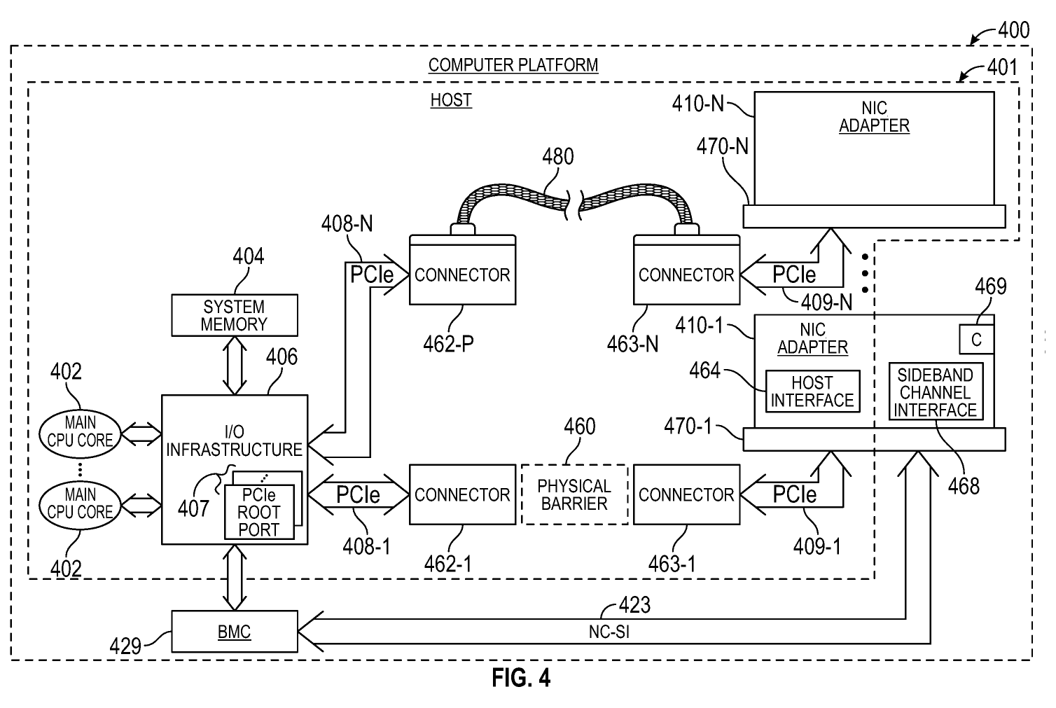

Referring to FIG. 4, in accordance with example implementations, a computer platform 400 includes physical barrier-based host interface concealment features, which allow a BMC 429 of the computer platform 400 to exclusively use a NIC adapter 410-1. The BMC 129 and the NIC adapter 110-1 of FIG. 1 are examples of the BMC 429 and the NIC adapter 410-1 of FIG. 4. For the example implementation depicted in FIG. 4, the NIC adapter 410-1 includes a host interface 464 and a sideband channel interface 468. Moreover, as depicted in FIG. 4, the BMC 429 communicates with the sideband channel interface 468 via a sideband channel bus 423, such as an NC-SI-compliant bus.

As depicted in FIG. 4, the computer platform 400 may include N card edge connectors 470 (example card edge connectors 470-1 and 470-N being depicted in FIG. 4), which receive N respective NIC adapters 410 (example NIC adapters 410-1 and 410-N being depicted in FIG. 4). As depicted in FIG. 4, the computer platform 400 may include an I/O infrastructure 406, main CPU cores 402 and a system memory 404, among other components. The I/O infrastructure 106, main CPU cores 102 and system memory 104 of FIG. 1 are examples of the I/O infrastructure 406, main CPU cores 402 and system memory 404, respectively.

The NIC adapters 410-1 to 410-N are installed in respective card edge connectors 470-1 to 470-N, respectively. The host interface of a NIC adapter 410 is not connected to a respective PCIe bus infrastructure of the host 401 by virtue of the NIC adapter 410 being installed in a card edge connector 470. Instead, the host interfaces of the NIC adapters 410 may be coupled to PCIe bus infrastructures of the computer platform 100 via cabling-based connections. In accordance with example implementations, each card edge connector 470-1 to 470-N is associated with a respective board-mounted I/O connector 463-1 to 463-N. In an example, an I/O connector 463 is mounted to the same substrate (e.g., motherboard or riser card) as the associated card edge connector 470. The PCIe infrastructures of a host 401 include P board-mounted I/O connectors 462-1 to 462-P (example I/O connectors 462-1 and 462-P being depicted in FIG. 4). In an example, the I/O connectors 462 may be mounted to the motherboard of the computer platform 400. In an example, the I/O connectors 462-1 to 462-P are associated with respective PCIe root ports 407.

A given PCIe infrastructure may be connected a given host interface 464 by connecting an I/O connector 462 associated with the PCIe infrastructure to an I/O connector 463 associated with the host interface 464. For example, for the NIC adapter 410-N, the host interface of the NIC adapter 410-N is connected to a particular PCIe infrastructure of the host 401 by a jumper cable 480.

In an example, the I/O connector 463 is mounted to the same substrate (e.g., motherboard or riser card) as the associated card edge connector 470 and connects to a PCI bus segment 409 that is connected to the associated card edge connector 470. In an example, the I/O connector 462 is mounted to the motherboard of the computer platform 400 and is connected to a PCIe segment 408 that is associated with a particular PCIe port (e.g., a root port or switch port). In an example, the I/O connectors 462 and 463 are Mini Cool Edge I/O (MCIO) connectors that are constructed to mate with complementary jumper cable-located MCIO connectors.

The NIC adapter 410, for the example implementation of FIG. 4, is assigned to the BMC 429. Unlike the exemplary NIC adapter 410-N, the host interface cabling connection for the NIC adapter 410-1 is purposefully omitted. Stated differently, a jumper cable does not connect the host interface 464 of the NIC adapter 410-1 to a PCIe bus infrastructure of the host 401, and correspondingly, a physical barrier 460 exists, which isolates the host 401 from the host interface 464. The physical barrier 460 prevents the host 401 from discovering or using the host interface 464 of the NIC adapter 410-1.

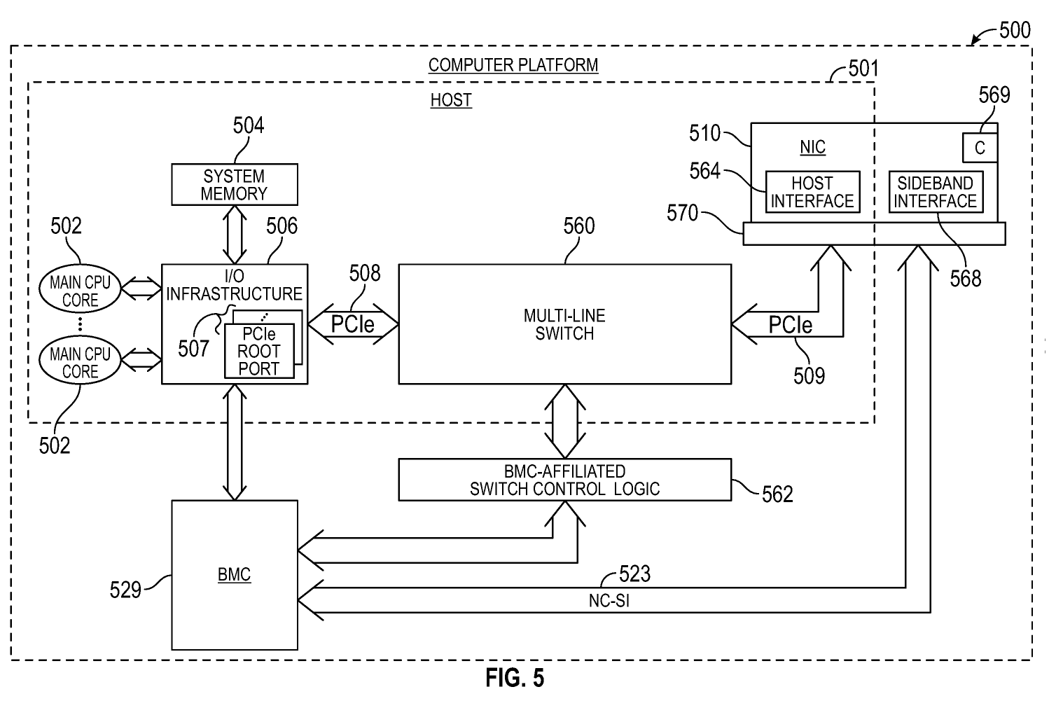

Referring to FIG. 5, in accordance with example implementations, a computer platform 500 includes a NIC adapter 510. Although a single NIC adapter 510 is depicted in FIG. 5, in accordance with further implementations, the computer platform 500 includes one or multiple additional NIC adapters 510. Moreover, each NIC adapter 510 may be associated with a multi-line switch 560. The multi-line switches 560 allow the selection of a particular NIC 510 for assignment to a BMC 529 of the computer platform 500. The multi-line switches 560 for the remaining NIC adapter(s) 510, in turn, may be used to connect the host interface(s) of the NIC adapter(s) to a host 501 of the computer platform 500. For this example, the NIC adapter 510 includes a host interface 564 and a sideband channel interface 568. Moreover, as depicted in FIG. 5, the BMC 529 communicates with the sideband interface 568 via a sideband channel bus 523, such as an NC-SI bus.

As depicted in FIG. 5, the NIC adapter 510 is installed in a card edge connector 570. The computer platform 500 includes an I/O infrastructure 506, main CPU cores 502 and a system memory 504, among other components. The I/O infrastructure 106, main CPU cores 102 and system memory 104 of FIG. 1 are examples of the I/O infrastructure 506, main CPU cores 502 and system memory 504, respectively.

Because, for this example, the NIC adapter 510 is assigned to the BMC 529, the associated multi-line switch 560 isolates the host interface 564 of the NIC adapter 510 from a PCIe bus infrastructure of the host 501. The multi-line switch 560 has a multiple line switched path that is coupled between PCIe bus segments 508 and 509. The PCIe bus segment 508 is associated with a corresponding PCIe bus infrastructure of the host 501 and is associated with a corresponding PCIe root port 507 (out of multiple PCIe root ports 507).

In a first state of the multi-line switch 560, the switched path connects the PCIe bus segments 508 and 509 together. In a second state of the multi-line switch 560, the switched path isolates the PCIe bus segments 508 and 509. The multi-line switch 560 is placed in the second state for purposes of isolating the host interface 564 from the host 501. In an example, the multi-line switch 560 includes a collection of transmission gates (e.g., complementary metal oxide semiconductor (CMOS) pass gates), and each transmission gate is coupled between an associated line (e.g., an address, control or data line) of the PCIe bus segment 508 and a corresponding associated line of the PCIe bus segment 509. Continuing the example, the transmission gates operate in unison in response to a switch control signal, so that depending on the state of the switch control signal, the collection of transmission gates either couple the PCIe segments 508 and 509 together or isolate the PCIe segments 508 and 509 from each other. For the example implementation that is described herein, the transmission gates isolate the PCIe segments 508 and 509 for purposes of isolating the host interface 564 from the host 501. Due to this isolation, the host 501 does not discover or use the NIC adapter 510.

In an example, and as depicted in FIG. 5, the multi-line switch 560 is controlled by BMC-affiliated switch control logic 562. In an example, the switch control logic 562 is located inside a semiconductor package (e.g., the semiconductor package 157 of FIG. 1) that contains a secure enclave and management processing cores of the BMC 529. In another example, the switch control logic 562 is external to the semiconductor package. In another example, the switch control logic 562 is not affiliated with the BMC 529, but rather, the switch control logic 562 is controlled by system firmware responsive to a boot of the host 501.

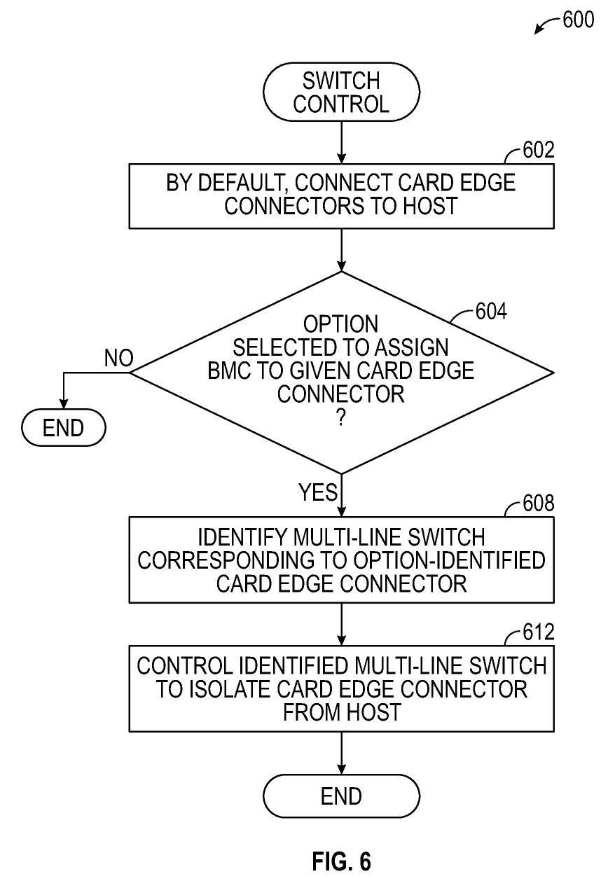

FIG. 6 depicts a technique 600 to control multi-line switches of a computer platform for purposes of selectively isolating a NIC adapter from a host. Referring to FIG. 6, the multi-line switches are associated with respective card edge connectors of the computer platform. In an example the technique 600 is performed responsive to a power up, or boot, of the host. In another example, the technique 600 is performed prior to the boot of the host. The multi-line switch 560 of FIG. 5 is an example of a multi-line switch controlled in connection with the technique 600. In an example, the technique 600 is performed, at least in part, by switch control logic, such as the BMC-affiliated switch control logic 562 of FIG. 5. In another example, the technique 600 is performed, at least in part, by system firmware.

In accordance with example implementations, the technique 600 includes, pursuant to block 602, connecting card edge connectors of the computer platform, by default, to the host. In an example, block 602 includes placing each multi-line switch, by default, in a state in which the multi-line switch couples the associated host interface to the host. In an example, block 602 may be performed prior to the host booting.

In another example, the multi-line switches are powered by a main power supply of the computer platform, and when the main power supply comes up, each multi-line switch self-initializes to a state in which the multi-line switch connects the associated host interface to the host. In another example, the multi-line switches are powered by an auxiliary power supply of the computer platform, and when the auxiliary power supply comes up, each multi-line switch self-initializes to a state in which the multi-line switch connects the associated host interface to the host.

Pursuant to decision block 604, the technique 600 includes determining whether a configuration option (e.g., a configuration option for the BMC or a UEFI option) has been selected to conceal the host interface of a NIC adapter. Stated differently, the selection of the configuration option assigns a particular NIC adapter uniquely to the BMC. In an example, the option identifies a particular card edge connector in which a NIC adapter that is to be used by the BMC is installed.

In response to the selection of the configuration option, the technique 600 includes, pursuant to block 608, identifying the multi-line switch corresponding to the identified card edge connector. Pursuant to block 612, the technique 600 includes controlling the identified multi-line switch to place the switch in a state to isolate the host interface of the NIC adapter that is installed in the identified card edge connector from the host.

Other implementations are contemplated, which are within the scope of the appended claims. For example, the BMC may be a virtual BMC. In another example, the BMC may be a firmware-based BMC. In accordance with further implementations, a NIC adapter may be dedicated to the exclusive use of a management controller other than a baseboard management controller. In an example, the management controller may be a chassis management controller. In another example, the management controller may be a rack management processor.

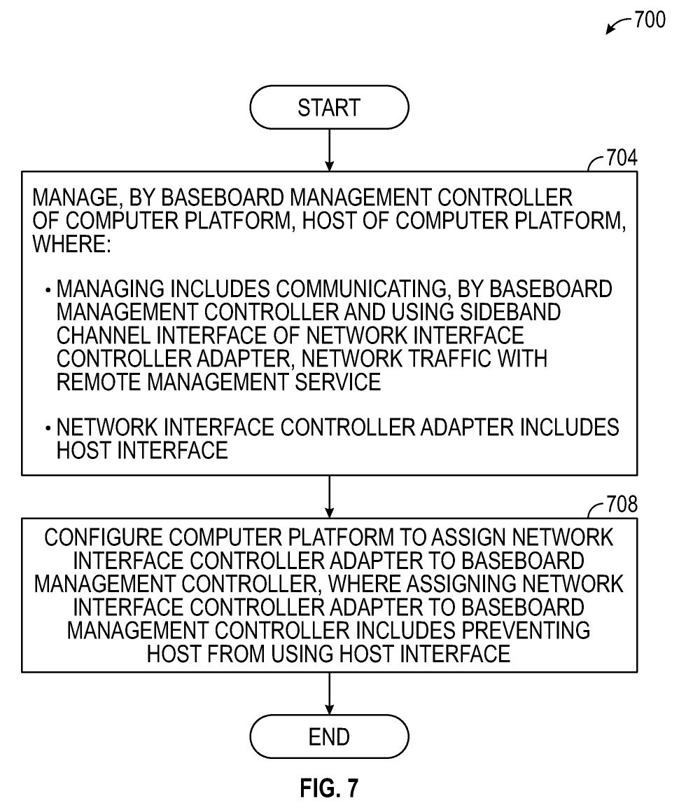

Referring to FIG. 7, in accordance with example implementations, a technique 700 includes managing (block 704), by a baseboard management controller of a computer platform, a host of the computer platform. In examples, the computer platform is a server, such as a rack server, an enclosure-based server (e.g., a blade server) or a stand-alone server (e.g., a tower server). In other examples, the computer platform 100 may be a component other than a server, such as a client, a desktop, a smartphone, a wearable computer, a networking component, a gateway, a network switch, a storage array, a portable electronic device, a portable computer, a tablet computer, a thin client, a laptop computer, a television, a modular switch, a consumer electronics device, an appliance, an edge processing system, a sensor system, a watch, a removable peripheral card, or, in general, any other processor-based electronic device.

The host provides one or multiple application operating environments in which application workloads run, or execute. A virtual machine is an example of an application operating environment. A bare-metal environment is another example of an application operating environment. A container is another example of an application operating environment.

In an example, managing the host includes the base management controller performing one or multiple management-related functions for the host. As examples, the baseboard management controller provides such management-related functions as operating system runtime services; resource detection and initialization; and pre-operating system services. In other examples, the management-related functions include the baseboard management controller monitoring telemetry values (e.g., cooling fan speeds or temperature sensors) and reporting unexpected or out-of-range telemetry values. In other examples, management-related functions may be remotely-managed functions. As examples, the remotely managed functions include KVM functions; virtual power functions (e.g., remotely activated functions to remotely set a power state, such as a power conservation state, a power on, a reset state or a power off state); and/or virtual media management functions.

In an example, managing the host includes the baseboard management controller performing one or multiple security-related functions for the host. In an example of a security-related function, a secure enclave of the baseboard management controller validates firmware that, after validation, is executed by the baseboard management controller. In another example of a security-related function, the secure enclave manages the storage of cryptographic artifacts (e.g., certificates, keys, digital certificates and seeds) for the host. In another example of a security-related function, the secure enclave provides one or multiple cryptographic services, such as a key generation service, a signature validation service, an encryption service, a decryption service, a hashing service, a true random number generation service or DRNG service.

In another example of a security-related service, the secure enclave detects and reports an unexpected inventory of the host. In another example of a security-related service, the secure enclave reports an attestation value for the computer platform. In another example of a security-related service, the secure enclave monitors environmental signals (e.g., sensor signals representing a die temperature, a clock rate, a supply voltage magnitude, an enclosure opening status, a removal status, and so forth) of the computer platform for purposes of detecting tampering, and the secure enclave reports any detected tampering events.

Managing the host includes, as depicted in block 704, communicating, by the baseboard management controller and using a sideband channel interface of a network interface controller adapter, network traffic with a remote management service. In an example of the network traffic, the baseboard management controller sends a message to the remote management service to report unexpected or out-of-range telemetry value associated with the host. In another example, the baseboard management controller sends a message to the remote management service to report a detected hardware fault associated with a hardware component of the host. In another example, the baseboard management controller sends a message to the remote management service to report a detected software fault associated with the host. In another example, the messages are related to the baseboard management controller requesting and downloading a firmware upgrade package or software patch. In another example, the messages correspond to an inquiry, from the remote management service, about an inventory or configuration, of the host and a corresponding response from the baseboard management controller. In other examples, the messages are related to configuring the host, controlling host power up or managing virtual media.

In another example of network traffic, a message is sent by the baseboard management controller to report detected tampering with the computer platform. In another example, the baseboard management controller sends a message to report an unexpected inventory. In another example, the baseboard management controller sends a message to report an attestation value (e.g. a signed measurement digest) measured during a measured boot. In another example, the baseboard management controller sends a message to report an unexpected measurement during a trusted boot. In another example, the baseboard management controller sends a message to report a failure of the validation of the initial portion of system firmware. In another example, the message relates to a request from the remote management service to add, change or delete a cryptographic artifact. In another example, the message relates to changing an ownership token associated with the baseboard management controller's firmware management stack.

In an example, communicating with the sideband channel interface, as depicted in block 704, includes communicating over an NC-SI bus. In other examples, communicating with the sideband channel interface includes communicating with an SPI bus, an I2C bus, an I3C bus, an SMB, or another type of bus. paragraph.

As depicted in block 704, the network interface controller adapter includes a host interface. In an example, the host interface is a PCIe-compliant interface. In another example, the host interface is associated with a bus other than a PCIe bus, such as an Infiniband bus.

Pursuant to block 708, the technique 700 includes configuring the computer platform to assign the network interface controller adapter to the baseboard management controller. Assigning the network interface controller adapter to the baseboard management controller includes preventing the host from using the host interface. In an example, assigning the network interface controller adapter to the baseboard management controller includes preventing the host from discovering the host interface. In an example, preventing the host from using the host interface includes disabling the host interface. In an example, preventing the host from using the host interface includes maintaining the host interface in a reset state. In an example, preventing the host from using the host interface includes suppressing link training for the host interface.

In an example, preventing the host from using the host interface includes using a physical barrier to isolate the host interface from a bus infrastructure of the host. In an example, preventing the host from using the host interface includes purposefully omitting a jumper cable that would otherwise connect the host interface to a bus infrastructure of the host. In an example, preventing the host from using the host interface includes disabling a root port of a bus infrastructure that is coupled to the host interface. In an example, preventing the host from using the host interface includes placing a switch in a state to isolate the host interface from a bus infrastructure of the host.

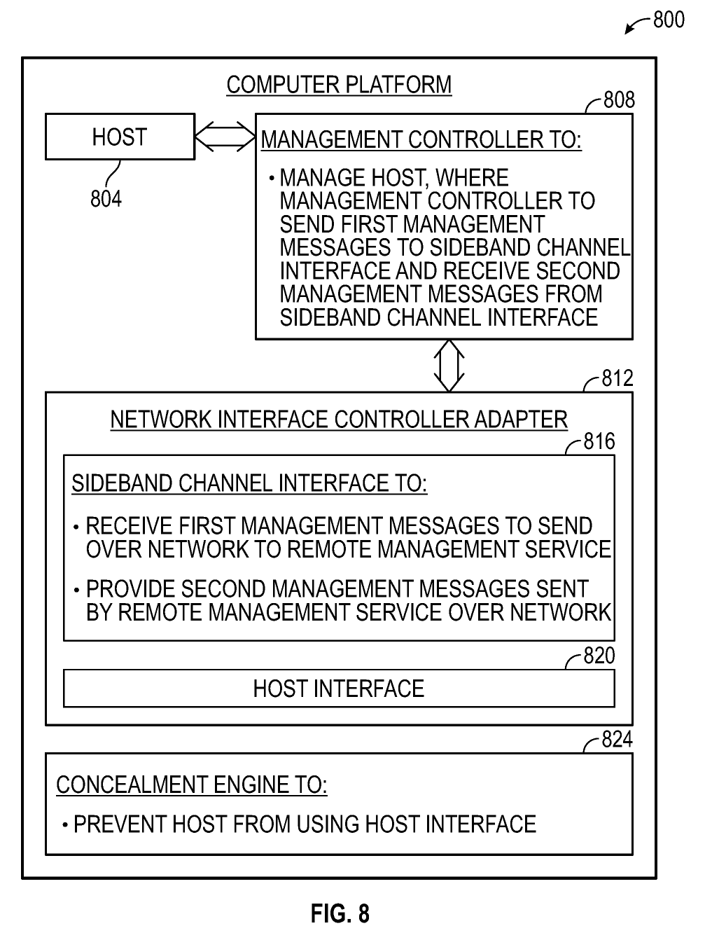

Referring to FIG. 8, in accordance with example implementations, a computer platform 800 includes a host 804; a network interface controller adapter 812; a management controller 808; and a concealment engine 824. In examples, the computer platform 800 is a server, such as a rack server, an enclosure-based server (e.g., a blade server) or a stand-alone server (e.g., a tower server). In other examples, the computer platform 800 may be a component other than a server, such as a client, a desktop, a smartphone, a wearable computer, a networking component, a gateway, a network switch, a storage array, a portable electronic device, a portable computer, a tablet computer, a thin client, a laptop computer, a television, a modular switch, a consumer electronics device, an appliance, an edge processing system, a sensor system, a watch, a removable peripheral card, or, in general, any other processor-based electronic device.

In an example, the management controller 808 is a baseboard management controller. In an example, the baseboard management controller corresponds to a semiconductor package that is mounted to a motherboard of the computer platform 800. In another example, the management controller 808 is a firmware-based baseboard management controller. In another example, the management controller 808 is a virtual baseboard management controller. In other examples, the management controller 808 is a chassis management controller or a rack management processor. In an example, the network interface controller adapter 812 is an OCP3 NIC-compliant adapter.

In an example, the concealment engine 824 is a combination of one or more hardware processing circuits and machine-readable instructions (software and/or firmware) executable on the one or more hardware processing circuits. In an example, the concealment engine 824 is formed by a hardware processor executing machine-readable instructions that are stored in a memory. In other examples, the concealment engine 824 is formed in whole or in part by a CPLD, a PLD, an ASIC, an FPGA or other hardware.

The network interface controller adapter 812 includes a sideband channel interface 816 and a host interface 820. In an example, the sideband channel interface 816 is an NC-SI-compliant interface. In other examples, the sideband channel interface 816 is constructed to communicate with an SPI bus, an I2C bus, an I3C bus, an SMB, or another type of bus. In an example, the host interface 820 is a PCIe-compliant interface. In another example, the host interface 820 is associated with a bus other than a PCIe bus, such as an Infiniband bus.

The sideband channel interface 816 receives first management messages to send over a network to a remote management service and provides second management messages, which are sent by the remote management service over the network. The management controller 808 manages the host 804. The management controller 808 sends the first management messages to the sideband channel interface 816 and receives the second management messages from the sideband channel interface 816. In example, the first management messages include one or multiple of a message to report an out-of-range telemetry value, a message to report a hardware fault, a message to report an unexpected inventory, a message to report tampering, a message to report an inventory, a message to report a configuration a message to request firmware, or a message to send an attestation value. In example, the first management messages include one or multiple of a message to request a power down of the host; a message to provide a firmware download link; a message to request an inventory; an acknowledgement message; a message to request a configuration change; or a message to add, change or delete a cryptographic artifact stored in or to be stored in the management controller.

The concealment engine 824 prevents the host 804 from using the host interface 820. In an example, the concealment engine 824 disables the host interface 820 to prevent the host 804 from using the host interface 820. In another example, the concealment engine 824 maintains the host interface 820 in a reset state to prevent the host 804 from using the host interface 820. In an example, the concealment engine 824 suppresses link training for the host interface 820 to prevent the host 804 from using the host interface 820. In another example, the concealment engine 824 operates a switch to isolate the host interface 820 from a bus infrastructure of the host to prevent the host 804 from using the host interface 820. In another example, the concealment engine 824 disables a root port of a bus infrastructure of the host to prevent the host 804 from using the host interface 820.

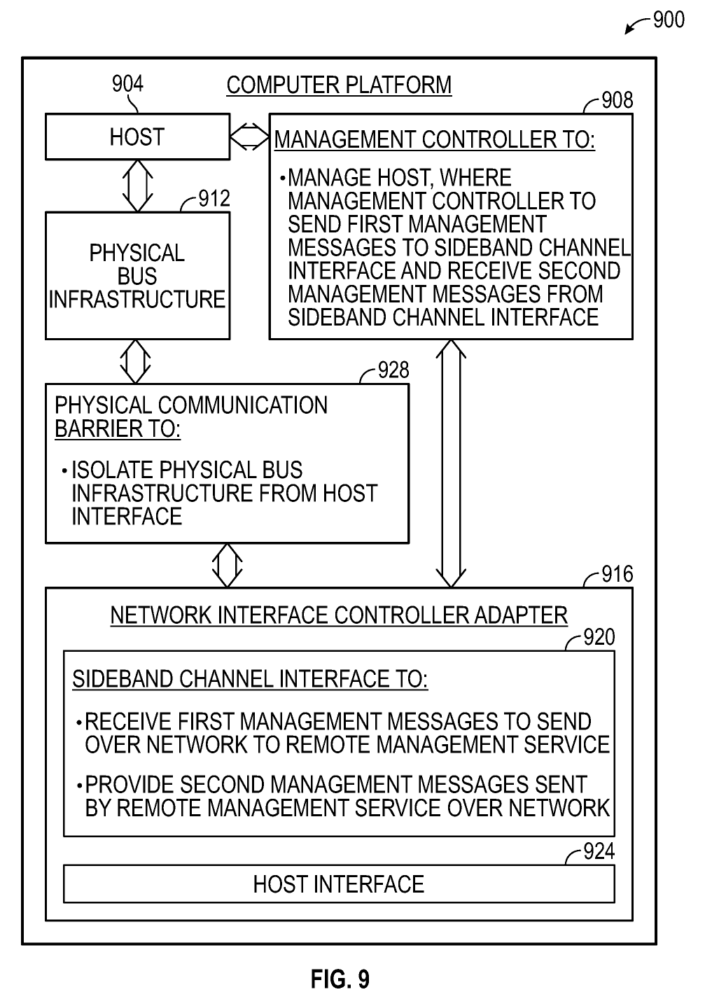

Referring to FIG. 9, in accordance with example implementations, a computer platform 900 includes a host 904; a network interface controller adapter 916; a management controller 908; a physical bus infrastructure 912; and a physical communication barrier 928. In examples, the computer platform 900 is a server, such as a rack server, an enclosure-based server (e.g., a blade server) or a stand-alone server (e.g., a tower server). In an example, the network interface controller adapter 916 is an OCP3 NIC-compliant adapter. In examples, the management controller 908 may be a baseboard management controller, a chassis management controller or a rack management processor. In an example, the physical bus infrastructure is a PCIe bus infrastructure. In an example, the physical communication barrier is the absence of a jumper cable to couple the network interface controller adapter to the physical bus infrastructure 912. In an example, the physical communication barrier 928 is a multi-line switch of the host placed in a state to isolate the network interface controller adapter from the physical bus infrastructure 912.

The network interface controller adapter 916 includes a sideband channel interface 920 and a host interface 924. In an example, the sideband channel interface 920 is an NC-SI-compliant interface. In other examples, the sideband channel interface 920 is constructed to communicate with an SPI bus, an I2C bus, an I3C bus, an SMB, or another type of bus. In an example, the host interface 924 is a PCIe-compliant interface. In another example, the host interface is associated with a bus other than a PCIe bus, such as an Infiniband bus.

The sideband channel interface 920 receives first management messages to send over a network to a remote management service and provides second management messages, which are sent by the remote management service over the network. In example, the first management messages include one or multiple of a message to report an out-of-range telemetry value, a message to report a hardware fault, a message to report an unexpected inventory, a message to report tampering, a message to report an inventory, a message to report a configuration a message to request firmware, or a message to send an attestation value. In example, the first management messages include one or multiple of a message to request a power down of the host; a message to provide a firmware download link; a message to request an inventory; an acknowledgement message; a message to request a configuration change; or a message to add, change or delete a cryptographic artifact stored in or to be stored in the management controller.

The management controller 908 manages the host 904. The management controller 908 sends the first management messages to the sideband channel interface 920 and receives the second management messages from the sideband channel interface 920. The physical bus infrastructure 912 is coupled to the host 904. The physical communication barrier 928 isolates the physical bus infrastructure 912 from the host interface 924. In an example, the physical bus infrastructure 912 is a PCIe bus infrastructure.

In accordance with example implementations, the computer platform includes a physical bus infrastructure that is coupled to the host. Preventing the host from using the host interface includes providing a physical communication barrier between the physical bus infrastructure and the host interface to prevent the host from communicating with the host interface. Among the particular advantages, host network traffic is not comingled with management network traffic, and the network interface controller adapter may be selected from a wide variety of available network interface controller adapters to provide a particular network interface for the baseboard management controller.

In accordance with example implementations, the physical bus infrastructure includes a jumper cable connector. Providing the physical communication barrier includes isolating the jumper cable connector from the host interface. Among the particular advantages, host network traffic is not comingled with management network traffic, and the network interface controller adapter may be selected from a wide variety of available network interface controller adapters to provide a particular network interface for the baseboard management controller.

In accordance with example implementations, providing the physical communication barrier includes operating a switch that is coupled between the host interface and the physical bus infrastructure to isolate the physical bus infrastructure from the host interface. Among the particular advantages, host network traffic is not comingled with management network traffic, and the network interface controller adapter may be selected from a wide variety of available network interface controller adapters to provide a particular network interface for the baseboard management controller.

In accordance with example implementations, preventing the host from using the host interface includes disabling the host interface. Among the particular advantages, host network traffic is not comingled with management network traffic, and the network interface controller adapter may be selected from a wide variety of available network interface controller adapters to provide a particular network interface for the baseboard management controller.

In accordance with example implementations, preventing the host from using the host interface includes preventing the host from discovering the host interface. Among the particular advantages, host network traffic is not comingled with management network traffic, and the network interface controller adapter may be selected from a wide variety of available network interface controller adapters to provide a particular network interface for the baseboard management controller.

In accordance with example implementations, the host interface is placed in a reset state responsive to a power up of the host. Responsive to the power up of the host, a determination is made that a clock signal associated with the host interface is stabilized and a power supply voltage associated with the host interface is stabilized. Preventing the host from discovering the host interface includes, responsive to the power up of the host, after determining that the clock signal is stabilized and after determining that the power supply voltage is stabilized, maintaining the host interface in the reset state. Among the particular advantages, host network traffic is not comingled with management network traffic, and the network interface controller adapter may be selected from a wide variety of available network interface controller adapters to provide a particular network interface for the baseboard management controller.

In accordance with example implementations, preventing the host from discovering the host interface includes holding the host interface in a reset state after a boot of the host. Among the particular advantages, host network traffic is not comingled with management network traffic, and the network interface controller adapter may be selected from a wide variety of available network interface controller adapters to provide a particular network interface for the baseboard management controller.

In accordance with example implementations, preventing the host from discovering the host interface includes disabling training of a communication link that is associated with the host interface. Disabling training of the communication link includes determining that the communication link is ready to be trained and suppressing the training after determining that the communication link is ready to be trained. Among the particular advantages, host network traffic is not comingled with management network traffic, and the network interface controller adapter may be selected from a wide variety of available network interface controller adapters to provide a particular network interface for the baseboard management controller.

In accordance with example implementations, the host interface is associated with a communication bus. The host includes a root port to allow a main hardware processor of the host to access the communication bus. Disabling the host interface includes disabling the root port. Among the particular advantages, host network traffic is not comingled with management network traffic, and the network interface controller adapter may be selected from a wide variety of available network interface controller adapters to provide a particular network interface for the baseboard management controller.

In accordance with example implementations, communicating the message includes at least one of sending, by the baseboard management controller, a first message to notify the remote management service about an event associated with the host; sending, by the baseboard management controller, a second message to request a firmware update; or sending, by the remote management service, a third message to request the baseboard management controller to perform a management function for the host. Among the particular advantages, host network traffic is not comingled with management network traffic, and the network interface controller adapter may be selected from a wide variety of available network interface controller adapters to provide a particular network interface for the baseboard management controller.

In the context that is used herein, a BMC is a specialized service processor that monitors the physical state of a server or other hardware using sensors and communicates with a management system through a management network. The BMC may also communicate with applications executing at the operating system level through IOCTL interface drivers, REST API calls, or some other system software proxy that facilitates communication between the BMC and applications. The BMC may have hardware level access to hardware devices that are located in a server chassis including system memory. The BMC may be able to directly modify the hardware devices. The BMC may operate independently of the operating system of the system in which the BMC is disposed. A BMC may be located on the motherboard or main circuit board of the server or other device to be monitored.

The fact that a BMC is mounted on a motherboard of the managed server/hardware or otherwise connected or attached to the managed server/hardware does not prevent the BMC from being considered “separate” from the server/hardware. As used herein, BMC has management capabilities for sub-systems of a computing device, and is separate from a processing resource that executes an operating system of a computing device. The BMC is separate from a processor, such as a central processing unit, which executes a high-level operating system or hypervisor on a system.

The detailed description set forth herein refers to the accompanying drawings. Wherever possible, the same reference numbers are used in the drawings and the foregoing description to refer to the same or similar parts. It is to be expressly understood, however, that the drawings are for the purpose of illustration and description only. While several examples are described in this document, modifications, adaptations, and other implementations are possible. Accordingly, the detailed description does not limit the disclosed examples. Instead, the proper scope of the disclosed examples may be defined by the appended claims.

The terminology used herein is for the purpose of describing particular examples only and is not intended to be limiting. As used herein, the singular forms "a," "an," and "the" are intended to include the plural forms as well, unless the context clearly indicates otherwise. The term "plurality," as used herein, is defined as two or more than two. The term "another," as used herein, is defined as at least a second or more. The term "connected," as used herein, is defined as connected, whether directly without any intervening elements or indirectly with at least one intervening element, unless otherwise indicated. Two elements can be coupled mechanically, electrically, or communicatively linked through a communication channel, pathway, network, or system. The term "and/or" as used herein refers to and encompasses any and all possible combinations of the associated listed items. It will also be understood that, although the terms first, second, third, etc. may be used herein to describe various elements, these elements should not be limited by these terms, as these terms are only used to distinguish one element from another unless stated otherwise or the context indicates otherwise. As used herein, the term "includes" means includes but not limited to, the term "including" means including but not limited to. The term "based on" means based at least in part on.

While the present disclosure has been described with respect to a limited number of implementations, those skilled in the art, having the benefit of this disclosure, will appreciate numerous modifications and variations therefrom. It is intended that the appended claims cover all such modifications and variations.

What is claimed is:

1. A method comprising:
managing, by a baseboard management controller of a computer platform, a host of the computer platform, wherein:
the managing comprises communicating, by the baseboard management controller and using a sideband channel interface of a network interface controller adapter, network traffic with a remote management service; and
the network interface controller adapter comprises a host interface; and
configuring the computer platform to assign the network interface controller adapter to the baseboard management controller, wherein assigning the network interface controller adapter to the baseboard management controller comprises preventing the host from using the host interface.

2. The method of claim 1, wherein:
the computer platform comprises a physical bus infrastructure coupled to the host; and
preventing the host from using the host interface comprises providing a physical communication barrier between the physical bus infrastructure and the host interface to prevent the host from communicating with the host interface.

3. The method of claim 2, wherein:
the physical bus infrastructure comprises a jumper cable connector; and
providing the physical communication barrier comprises isolating the jumper cable connector from the host interface.

4. The method of claim 2, wherein:
providing the physical communication barrier comprises operating a switch coupled between the host interface and the physical bus infrastructure to isolate the physical bus infrastructure from the host interface.

5. The method of claim 1, wherein preventing the host from using the host interface comprises disabling the host interface.

6. The method of claim 5, wherein:
the host interface is associated with a communication bus;
the host comprises a root port to allow a main hardware processor of the host to access the communication bus; and
disabling the host interface comprises disabling the root port.

7. The method of claim 1, wherein preventing the host from using the host interface comprises preventing the host from discovering the host interface.

8. The method of claim 7, further comprising:
responsive to a power up of the host, placing the host interface in a reset state; and
responsive to the power up of the host, determining that a clock signal associated with the host interface is stabilized and determining that a power supply voltage associated with the host interface is stabilized;
wherein preventing the host from discovering the host interface comprises, responsive to the power up of the host, after determining that the clock signal is stabilized and after determining that the power supply voltage is stabilized, maintaining the host interface in the reset state.

9. The method of claim 7, wherein preventing the host from discovering the host interface comprises holding the host interface in a reset state after a boot of the host.

10. The method of claim 7, wherein:
preventing the host from discovering the host interface comprises disabling training of a communication link associated with the host interface; and
disabling training of the communication link comprises:
determining that the communication link is ready to be trained; and
suppressing the training after determining that the communication link is ready to be trained.

11. The method of claim 1, wherein communicating the network traffic comprises at least one of:
sending, by the baseboard management controller, a first message of the messages to notify the remote management service about an event associated with the host;
sending, by the baseboard management controller, a second message of the messages to request a firmware update; or
sending, by the remote management service, a third message of the messages to request the baseboard management controller to perform a management function for the host.

12. A computer platform comprising:
a host;
a network interface controller adapter comprising:
a sideband channel interface to receive first management messages to send over a network to a remote management service and provide second management messages sent by the remote management service over the network; and
a host interface;
a management controller to manage the host, wherein the management controller to send the first management messages to the sideband channel interface and receive the second management messages from the sideband channel interface; and
a concealment engine to prevent the host from using the host interface.

13. The computer platform of claim 12, wherein the network interface controller adapter comprises an optical network interface controller card.

14. The computer platform of claim 12, wherein the concealment engine to further, responsive to a power up of the host:
place the host interface in a reset state; and
determine that a clock signal associated with the host interface is stabilized and determine that a power supply voltage associated with the host interface is stabilized; and
after determining that the clock signal is stabilized and after determining that the power supply voltage is stabilized, maintain the host interface in the reset state.

15. The computer platform of claim 12, wherein the concealment engine to further suppress a link training of a communication bus coupled to the host interface to prevent the host from discovering the host interface.

16. The computer platform of claim 12, wherein:
the host interface is associated with a communication bus;
the host comprises a hardware processor and a root port to allow the hardware processor to access the communication bus; and
the concealment engine to further disable the root port to prevent the host from discovering the host interface.

17. The computer platform of claim 12, wherein the concealment engine to configure system firmware of the computer platform to disable communication, by the host, with the host interface.

18. A computer platform comprising:
a host;
a network interface controller adapter comprising:
a sideband channel interface to receive first management messages to send over a network to a remote management service and provide second management messages sent by the remote management service over the network; and
a host interface to communicate with the network;
a management controller to manage the host, wherein the management controller to send the first management messages to the sideband channel interface and receive the second management messages from the sideband channel interface;
a physical bus infrastructure coupled to the host; and
a physical communication barrier to isolate the physical bus infrastructure from the host interface.

19. The computer platform of claim 18, further comprising:
a motherboard comprising a first jumper cable connector coupled to the physical bus infrastructure and a second jumper cable connector coupled to the host interface; and
the physical communication barrier corresponds to the absence of an electrical connection between the first jumper cable connector and the second jumper cable connector.

20. The computer platform of claim 18, wherein:
the physical communication barrier comprises a switch operable to isolate the physical bus infrastructure from the host interface.
